(19) United States
(12) Patent Application Publication
(10) Pub. No.: US 2016/0162106 A1
(43) Pub. Date: Jun. 9, 2016

(54) METHOD AND ELECTRONIC DEVICE FOR CONTROLLING TOUCH INPUT

(71) Applicant: Samsung Electronics Co., Ltd., Gyeonggi-do (KR)

(72) Inventor: Yong-Joon JEON, Gyeonggi-do (KR)

(21) Appl. No.: 14/955,221

(22) Filed: Dec. 1, 2015

(30) Foreign Application Priority Data
Dec. 5, 2014 (KR) 10-2014-0174359

(51) Int. Cl. G06F 3/041; G09G 5/00; G06F 3/14

(52) U.S. Cl. CPC G06F 3/0416; G06F 3/1423; G09G 5/006; G06F 2203/04104

(57) ABSTRACT

An apparatus and a method for controlling at least another electronic device in an electronic device. The method of may include sensing at least one sub electronic device functionally connected to the first electronic device, detecting a multi-touch input, determining whether the multi-touch input is detected through single electronic device of the first electronic device or at least one sub electronic device, and controlling an application based on whether the multi-touch input is detected through the single electronic device.

### CLAIM OF PRIORITY

This application claims the priority under 35 U.S.C. §119(a) from Korean Application Serial No. 10-2014-0174359, which was filed in the Korean Intellectual Property Office on Dec. 5, 2014, the entire content of which is hereby incorporated by reference in its entirety.

### BACKGROUND

1. Field of the Disclosure

Various embodiments of the present disclosure relate to an apparatus and a method for controlling a touch input in an electronic device.

2. Description of the Related Art

Different types of electronic devices have been have increased in popularity in recent years, and thus such electronic devices may use various input methods such as a touch, a voice and a gesture to maximize communicative capabilities.

When a user uses a plurality of electronic devices that includes a visual output, the user may use a plurality of displays in the plurality of electronic devices by connecting the plurality of displays in the plurality of electronic devices. For example, the user may operate a multi-screen service by connecting the plurality of displays in the plurality of electronic devices.

### SUMMARY

In a multi-screen service, a plurality electronic devices for providing the multi-screen service are connected to at least one control device, and the control device may control displays in each electronic device. For example, the control device may include at least one electronic device or at least another electronic device for providing the multi-screen service.

When the electronic devices for the multi-screen service includes a touch screen, there is a need for a control device method for processing a touch input detected through the touch screens of each of the electronic devices.

According to various embodiments of the present disclosure, a device and a method for controlling a display of at least another electronic device in an electronic device may be provided.

According to various embodiments of the present disclosure, a device and a method for processing a touch input detected through a plurality of other electronic devices for an expansion type multi-screen service in an electronic device may be provided.

According to various embodiments of the present disclosure, a method of operating a first electronic device may include detecting at least one sub electronic device functionally connected to the first electronic device, detecting a multi-touch input, determining whether the multi-touch input is detected through single electronic device of the first electronic device or the at least one sub electronic device, and controlling an application based on whether the multi-touch input is detected through the single electronic device.

According to various embodiments of the present disclosure, a first electronic device may include a touch screen, a memory and a processor. The processor, which comprises hardware circuitry configured for operation, may detect a multi-touch input, determine whether the multi-touch input is detected through single electronic device of the first electronic device or at least one sub electronic device functionally connected to the first electronic device, and control an application based on whether the multi-touch input is detected through the single electronic device.

### BRIEF DESCRIPTION OF THE DRAWINGS

The above and other aspects, features, and advantages of the present disclosure will become more apparent to a person of ordinary skill in the art from the following detailed description taken in conjunction with the accompanying drawings, in which:

FIG. 1 illustrates a block diagram of an electronic device according to various embodiments of the present disclosure;

FIG. 2 illustrates a block diagram of an electronic device according to various embodiments of the present disclosure;

FIG. 3 illustrates a structure of an expansion type multi-screen service according to various embodiments of the present disclosure;

FIG. 4 illustrates a structure for controlling at least another electronic device and a screen in an electronic device according to various embodiments of the present disclosure;

FIG. 5 illustrates a structure of a touch area using at least another electronic device recognized in an electronic device according to various embodiments of the present disclosure;

FIG. 6 illustrates a structure detecting a multi-touch input through at least another electronic device in an electronic device according to various embodiments of the present disclosure;

FIG. 7 illustrates a structure for copying an application according to various embodiments of the present disclosure;

FIG. 8 illustrates a flowchart for processing a touch input detected through at least another electronic device in an electronic device according to various embodiments of the present disclosure;

FIG. 9 illustrates a flowchart for processing a touch input detected through at least another electronic device in an electronic device according to various embodiments of the present disclosure; and

FIG. 10 illustrates a flowchart for processing a touch input detected through at least another electronic device in an electronic device according to various embodiments of the present disclosure.

### DETAILED DESCRIPTION

Hereinafter, various embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions may be omitted for clarity and conciseness as this application is written for a person of ordinary skill in the art.

The present disclosure may have various embodiments, and modifications and changes may be made therein. Therefore, the present disclosure will be described in detail with reference to particular embodiments shown in the accompanying drawings. However, it will be understood by a person of ordinary skill in the art that the present disclosure is not limited to the particular embodiments shown and described herein, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit the inclusion of one or more additional functions, operations, elements, and the like. In addition, a person of ordinary skill in the art will understand that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices that do not imply sequence but rather are identifiers. For example, a first element may be named a second element without departing from the scope of right of various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “ adapted to”, “made to”, according to a situation. The term “configured to (set to)” does not necessarily mean “specifically designed to” in a hardware level. Instead, the expression “apparatus configured to . . . ” may mean that the apparatus is “capable of when loaded with, for example, machine executable code . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor(AP), with hardware circuitry that can be operated to performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

The module or program module according to various embodiments of the present disclosure may further include additional elements disclosed herein, or omit some of the elements from various constructions. Operations performed by a module, programming module, or other elements according to various embodiments of the present disclosure may be executed in a sequential, parallel, repetitive, or heuristic manner. In addition, some of the operations may be executed in a different order or may be omitted, or other operations may be added.

An electronic device according to various embodiments of the present disclosure may be a device. For example, the electronic device according to various embodiments of the present disclosure may include at least one of: a smart phone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mount-device (HMD), an electronic glasses, an electronic clothing, an electronic bracelet, an electronic necklace, an electronic appcessory, an electronic tattoo, a smart mirror, or a smart watch).

In other embodiments, an electronic device may be a smart home appliance. For example, of such appliances may include at least one of: a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google TV); a game console(e.g., Xbox® PlayStation®); an electronic dictionary; an electronic key; a camcorder; or an electronic frame.

In other embodiments, an electronic device may include at least one of: a medical equipment (e.g., a mobile medical device (e.g., a blood glucose monitoring device, a heart rate monitor, a blood pressure monitoring device or a thermometer), a magnetic resonance angiography (MRA) machine, a magnetic resonance imaging (MRI) machine, a computed tomography (CT) scanner, or an ultrasound machine); a navigation device; a global positioning system (GPS) receiver; an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for vehicle; an industrial or home robot; an automatic teller's machine (ATM) of a financial institution, point of sale (POS) device at a retail store, or an internet of things device (e.g., a Lightbulb, various sensors, an electronic meter, a gas meter, a sprinkler, a fire alarm, a thermostat, a streetlamp, a toaster, a sporting equipment, a hot-water tank, a heater, or a boiler and the like).

In certain embodiments, an electronic device may include at least one of: a piece of furniture or a building/structure; an electronic board; an electronic signature receiving device; a projector; and various measuring instruments (e.g., a water meter, an electricity meter, a gas meter, or a wave meter).

An electronic device according to various embodiments of the present disclosure may also include a combination of one or more of the above-mentioned devices.

Further, it will become apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

Hereinafter, in various embodiments of the present disclosure, an electronic device may control at least another electronic device including a display (e.g., a touch screen). According to an embodiment, the electronic device and at least another electronic device may be functionally or physically separated. For example, the electronic device and at least another electronic device may be configured as one electronic device. For example, the electronic device and at least another electronic device may include different electronic devices which are physically separated. For example, at least one of the electronic device and at least another electronic device may be configured as one electronic device.

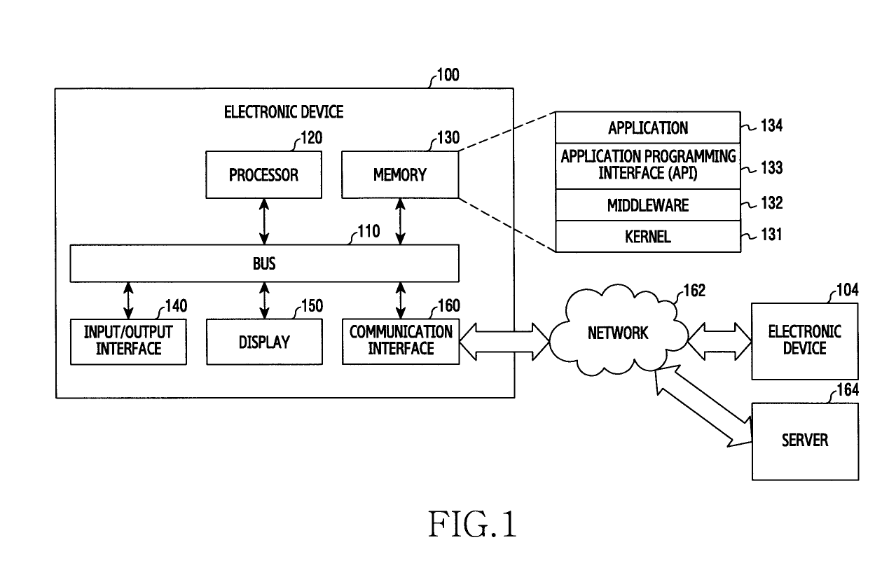

FIG. 1 illustrates a block diagram of an electronic device according to various embodiments.

Referring to FIG. 1, the electronic device 100 may include a bus 110, a processor 120, a memory 130, an input/output interface 140, a display 150, and a communication interface 160. In an embodiment, at least one of the elements of the electronic device 100 may be omitted, or other elements may be additionally included in the electronic device 100.

The bus 110 may be a circuit constructed for connecting the above-mentioned components (e.g., the processor 120, the memory 130, the input/output interface 140, the display 150, the communication interface 160 or the like) and transferring communication (for example, control messages) between the above-mentioned components.

The processor 120 which comprises hardware configured for operation may include one or more of a Central Processing Unit (CPU), an Application Processor (AP), or a Communication Processor (CP) and may operate as a controller or part of a controller. For example, the processor 120 may carry out operations or data processing related to control and/or communication of at least one other component of the electronic device 100.

According to an embodiment, the processor 120 of electronic device 100 may control a display of at least one another electronic device (e.g., another electronic device 104) functionally connected to the electronic device 100.

For example, the processor 120 of electronic device 100 may control the display of each of other electronic device such that the respective display may display different information (e.g., application information).

For example, the processor 120 of electronic device 100 may control the display of the at least one other electronic device such that the display of the at least other electronic device may display the same information (e.g., application information). Additionally, the processor 120 may control the display 150 such that the display 150 displays information the same as that of the at least one other electronic device.

For example, the processor 120 may control the display of each of other electronic devices communicatively coupled thereto such that the display of the other electronic devices may display information in divided areas of the screen that output specific contents (e.g., application information) related to at least another electronic device functionally connected to the electronic device 100. In other words, the screen may be divided and some of the area may output information regarding one or more electronic devices communicatively coupled to the electronic device 100. For example, the processor 120 of electronic device 100 may control the display 150 such that the display 150 displays all or at least some of contents displayed by at least another electronic device, such as electronic device 104 or server 164.

According to an embodiment, the processor 120 of electronic device 100 may process a touch input (e.g., a multi-touch input) detected through at least one of the electronic device 100 or at least another electronic device (e.g., the electronic device 104) functionally connected to the electronic device 100.

For example, the processor 120 of the electronic device 100 may detect a multi-touch through displays (e.g., touch screens) of the electronic device 100 and at least another electronic device functionally connected to the electronic device 100. The processor 120 of the electronic device 100 may identify whether a corresponding multi-touch is detected in the single electronic device (e.g., the electronic device 100 or 104) based on touch coordinates in which the multi-touch is detected. When the processor 120 of the electronic device 100 detects the multi-touch has occurred in the single electronic device, the processor 120 may process the multi-touch so as to correspond to a service provided from the electronic device in which the multi-touch is detected.

For example, when a plurality of electronic devices in which the multi-touch is detected display the same information in an expansion type service, (e.g., an expanded multi-screen service), the processor 120 of the electronic device 100 may process the multi-touch so as to correspond to a service provided from the electronic devices in which the multi-touch is detected. For example, the plurality of electronic devices in which the multi-touch is detected may include a plurality of electronic devices detecting each touch input included in the multi-touch detected in the processor 120. For example, a display of the expanded type service of the same information may display a type in which information on different divided areas having specific contents in the respective divided areas are displayed on the electronic device 100 and at least another electronic device functionally connected to the electronic device 100.

For example, when the plurality of electronic devices in which the multi-touch is detected each display the same information, the processor 120 may process the multi-touch or a single touch so as to correspond to a service provided from each electronic device in which the multi-touch is detected. For example, when the plurality of electronic devices in which the multi-touch is detected each display the same application, the processor 120 may synchronize the touch inputs detected in each electronic device. The processor 120 may control the provision of a service (or an event) corresponding to each touch input synchronized in each electronic device. For example, when the processor 120 of the electronic device 100 detects the multi-touch through the plurality of electronic devices displaying the same application, the processor 120 may identify a distance of touch coordinates. When the distance of the touch coordinates is included in a reference range, the processor 120 may select and process only one touch input among from the touch inputs included in the reference range.

With continued reference to FIG. 1, the memory 130 may include a volatile memory and/or a non-volatile memory.

The memory 130 may store commands or data related to one or more other components of the electronic device 100. According to an embodiment, the memory 130 may store software and/or a program for execution by a processor. For example, the program may include a kernel 131, middleware 132, an Application Programming Interface (API) 133, an application 134 or the like. At least some of the kernel 131, the middleware 132, or the API 133 may be referred to as an Operating System (OS).

The kernel 131 may control or manage system resources (for example, the bus 110, the processor 120, the memory 130 or the like) used for executing an operation or function implemented in other programs (for example, the middleware 132, the API 133, or the application 134). The kernel 131 may provide an interface that enables the middleware 132, the API 133, or the applications 134 to access individual elements of the electronic device 100 for control or management of the system resources.

The middleware 132 may serve as a relay for allowing the API 133 or the applications 134 to transmit/receive data to/from the kernel 131 through communication therewith. The middleware 132 may perform a control for a task request received from the application 134. For example, the middleware 132 may perform the control (e.g., scheduling or load balancing) for the task request using methods such as a method of assigning a priority of a usage of the system resource of the electronic device 100 to at least one application among the applications 134.

The API 133 may include an interface or a function (e.g., commands) for enabling the application 134 to control a function provided from the kernel 131 or the middleware 132. For example, the API 133 may include at least one interface such as a file control, a window control, an image process, or a text control.

The input/output interface 140 may serve as an interface that may transfer instructions or data input from a user or another external device to other component (s) of the electronic device 100. Further, the input/output interface 140 may output commands or data received from other component(s) of the electronic device 100 to the user or another external device.

With further reference to the electronic device 100 shown in FIG. 1, the display 150 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 150 may display various types of contents (for example, text, images, videos, icons, or symbols) for users. The display 150 may include a touch screen, and may receive, for example, a touch, gesture, proximity, or hovering input by using an electronic pen or a part of the user's body.

The communication interface 160 may connect communication between the electronic device 100 and an external device (e.g., another electronic device 104 or the server 164). For example, the communication interface 160 may be connected to the network 162 through wireless communication or wired communication, and may communicate with an external device other than the electronic device 104 or server 164, and/or may communicate with another device via the server.

For example, the wireless communication may use at least one of Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), Global System for Mobile Communications (GSM), or the like in the event that a cellular communication protocol is being used.

For example, the wireless communication may include at least one of, for example, WiFi, Bluetooth, Bluetooth Low Energy (BLE), Zigbee, Infrared Ray (IR) communication, ultrasonic waves communication or the like as a short range communication protocol in addition to or in place of the cellular communication protocol.

The wired communication may include, for example, at least one of a universal serial bus (USB), a high definition multimedia interface (HDMI), a recommended standard 232 (RS-232), a plain old telephone service (POTS) or the like.

The network 162 may include at least one of communication networks, for example, a computer network (e.g., a LAN or a WAN), the Internet, or a telephone network.

Another electronic device 104 may be a device of a type that is the same as or different from the electronic device 100. According to an embodiment, the server 164 may include a group of one or more servers, proxy servers, etc. According to various embodiments, all or some of the operations performed in the electronic device 100 may be performed by another electronic device 104 or a plurality of electronic devices (for example, another electronic device 104 and the server 164, or by two or more servers, or two or more electronic devices communicatively coupled to the electronic device 100).

According to an embodiment, when the electronic device 100 should perform some functions or services automatically or by a request, the electronic device 100 may delegate some of the performance to another device or devices. For example, the electronic device 100 may make a request for performing at least some functions related to the functions or services to another device (for example, the electronic device 104, or the server 164) instead of performing the functions or services by the electronic device 100 itself or additionally. Another electronic device (for example, the electronic device 104 or the server 164) may carry out the requested functions or the additional functions and transfer results thereof to the electronic device 100. The electronic device 100 may provide requested functions or services based on the received results or after additionally processing the received results. To this end, for example, cloud computing, distributed computing, or client-server computing technology may be used.

According to various embodiments of the present disclosure, the electronic device 100 may control a display of at least another electronic device and process a multi-touch using at least one module which is functionally or physically separated from the processor 120.

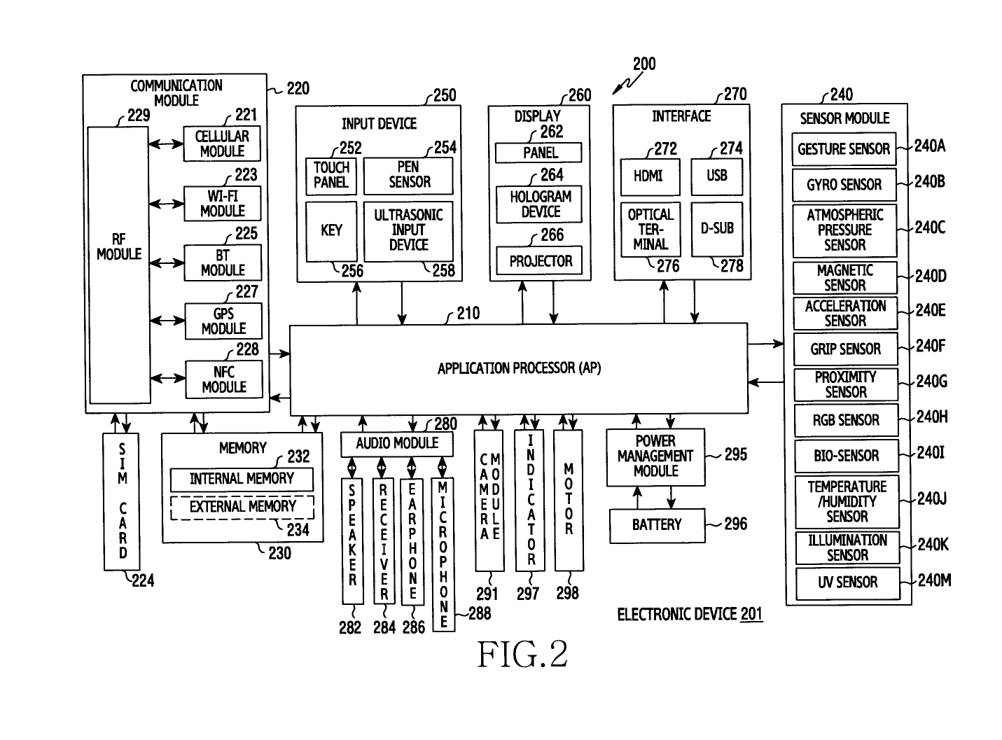

FIG. 2 illustrates a block diagram 200 of an electronic device 201 according to various embodiments of the present disclosure. For example, the electronic device 201 may form all or a part of the electronic device 100 illustrated in FIG. 1.

Referring now to FIG. 2, the electronic device 201 may include at least one Application Processor (AP) 210, a communication module 220, a Subscriber Identification Module (SIM) card 224, a memory 230 (non-transitory memory), a sensor module 240, an input device 250, a display 260, an interface 270, an audio module 280, an image sensor module 291, a power management module 295, a battery 296, an indicator 297, and a motor 298. An artisan should understand and appreciate that all of the aforementioned modules and those shown in FIG. 2 are statutory subject matter in accordance with 35 U.S.C. §101 and are not pure software or software per se.

The AP 210 may drive an operating system or an application program so as to control a plurality of hardware or software components connected to the AP 210, and may execute data processing and operation associated with various data including multimedia data. The AP 210 may be implemented by hardware such as, for example, a System on Chip (SoC). According to an embodiment, the AP 210 may further include a graphic processing unit (GPU) (not illustrated) that includes hardware configured for operation.

According to an embodiment, the AP 210 may be configured to control a display of at least another electronic device functionally connected to the AP 210.

According to an embodiment, the AP 210 may process a multi-touch detected through the electronic device 201 and at least another electronic device functionally connected to the electronic device 201.

The communication module 220 (e.g., the communication interface 160) typically includes hardware such as transmitter, receiver or transceiver, antenna(s), and may perform data transmission and reception between the electronic device 201 and another electronic device (e.g., electronic device 104) connected through a network. According to an embodiment, the communication module 220 may include a cellular module 221, a WiFi module 223, a BlueTooth (BT) module 225, a GPS module 227, an NFC module 228 or a Radio Frequency (RF) module 229 for transmission and/or reception utilizing the one of the modules according to a desired transmission and/or reception protocol.

The cellular module 221 may provide a voice call, a video call, a short message service (SMS), or an Internet service through a communication network (for example, LTE, LTE-A, CDMA, WCDMA, UMTS, WiBro, GSM or the like), just to name some non-limiting possible examples. Further, the cellular module 221 may distinguish between and authenticate electronic devices in a communication network using, for example, a subscriber identification module (for example, the SIM card 224). According to an embodiment, the cellular module 221 may perform at least some of the functions that the AP 210 may provide. For example, the cellular module 221 may perform at least some of the multimedia control functions.

According to an embodiment, the cellular module 221 may include a Communication Processor (CP). Further, the cellular module 221 may be implemented by, for example, an SoC. Although the elements such as the cellular module 221 (e.g., a communication processor), the memory 230 or the power management module 295 are illustrated as being separate from the AP 210 in FIG. 2, the AP 210 may include at least some of the aforementioned elements (e.g., the cellular module 221) according to an embodiment.

According to an embodiment, the AP 210 or the cellular module 221 (for example, the communication processor) may load a command or data received from at least one of a non-volatile memory and other components connected thereto to a volatile memory and process the loaded command or data. Further, the AP 210 or the cellular module 221 may store data received from or generated by at least one of other components in a non-volatile memory.

For example, each of the Wi-Fi module 223, the BT module 225, the GPS module 227, and the NFC module 228 may include a processor having circuitry configured for processing data transmitted/received through the corresponding module. Although each of the cellular module 221, the WiFi module 223, the BT module 225, the GPS module 227, and the NFC module 228 is shown as a separate block in FIG. 2, at least some (e.g., two or more) of the cellular module 221, the WiFi module 223, the BT module 225, the GPS module 227, and the NFC module 228 may be included in one integrated chip (IC) or IC package according to an embodiment. For example, at least some (for example, the communication processor corresponding to the cellular module 221 and the Wi-Fi processor corresponding to the Wi-Fi module 223) of processors corresponding to the cellular module 221, the Wi-Fi module 223, the BT module 225, the GPS module 227, and the NFC module 228 may be implemented as one SoC.

The RF module 229 may transmit and receive data, for example, RF signals. The RF module 229 may include, for example, a transceiver, a Power Amp Module (PAM), a frequency filter, a Low Noise Amplifier (LNA), an antenna and/or antenna array or the like, although not illustrated. Further, the RF module 229 may further include a component for transmitting and receiving an electromagnetic wave in the free airspace in wireless communication, for example, a conductor or a conductive wire. Although the cellular module 221, the Wi-Fi module 223, the BT module 225, the GPS module 227, and the NFC module 228 are illustrated to share one RF module 229 in FIG. 2, at least one of the cellular module 221, the Wi-Fi module 223, the BT module 225, the GPS module 227, and the NFC module 228 may transmit/receive the RF signal through a separate RF module according to an embodiment.

According to an embodiment, the RF module 229 may include at least one antenna of a main antenna and a sub antenna functionally connected to the electronic device 201. The communication module 220 may support a Multiple Input Multiple Output (MIMO) such as a diversity by using the main antenna and the sub antenna.

The SIM card 224 may be a card comprised of an integrated circuit including a subscriber identification module and may be inserted into a slot formed in a predetermined position of the electronic device. The SIM card 224 may include unique identification information (e.g. an integrated circuit card identifier (ICCID)) or unique subscriber information (e.g., an international mobile subscriber identity (IMSI)).

The memory 230 may include an internal memory 232 or an external memory 234. The internal memory 232 may, for example, include at least one of a volatile memory (for example, a dynamic random access memory (DRAM), a static RAM (SRAM), or a synchronous dynamic RAM (SDRAM)) and a non-volatile memory (for example, a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

According to an embodiment, the internal memory 232 may be a Solid State Drive (SSD). The external memory 234 may further include a flash drive, for example, a compact flash (CF), a secure digital (SD), a micro secure digital (Micro-SD), a mini secure digital (Mini-SD), an extreme digital (xD), a Memory Stick, or the like. The external memory 234 may be functionally connected to the electronic device 201 through various interfaces. According to an embodiment, the electronic device 201 may further include a storage device (or storage medium) such as a hard disc drive.

The sensor module 240 may measure a physical quantity or sense an operational state of the electronic device 201 and may convert the measured or sensed information to an electric signal. The sensor module 240 may include at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a Red/Green/Blue (RGB) sensor), a biometric sensor 240I, a temperature/humidity sensor 240J, an illumination sensor 240K, and an Ultra Violet (UV) sensor 240M, just to name some non-limiting possibilities. Additionally or alternatively, the sensor module 240 may, for example, include an E-nose sensor (not shown), an electromyography (EMG) sensor (not shown), an electroencephalogram (EEG) sensor (not shown), an electrocardiogram (ECG) sensor (not shown), an Infrared (IR) sensor (not shown), an iris sensor (not shown), a fingerprint sensor (not shown), or the like. The sensor module 240 may further include a control circuit for controlling one or more sensors included therein.

With continued reference to FIG. 2, the input device 250 may include a touch panel 252, a (digital) pen sensor 254, a key 256, or an ultrasonic input device 258. The touch panel 252 may recognize a touch input in at least one of, for example, a capacitive type, a resistive type, an infrared type, and an acoustic wave type. Further, the touch panel 252 may further include a control circuit. In the case of the capacitive type, physical contact or proximity recognition is possible. The touch panel 252 may further include a tactile layer. In this case, the touch panel 252 may provide a user with a tactile reaction.

The (digital) pen sensor 254 may be implemented, for example, using a method identical or similar to a method of receiving a touch input of a user, or using a separate recognition sheet. The key 256 may include, for example, a physical button, an optical key or a keypad. The ultrasonic input device 258 may identify data by sensing an acoustic wave in the electronic device 201 through an input unit generating an ultrasonic signal, and may perform a wireless recognition. According to an embodiment, the electronic device 201 may receive a user input from an external device (for example, a computer or a server) connected thereto using the communication module 220.

The display 260 (for example, the display 150) may include a panel 262, a hologram device 264 or a projector 266. For example, the panel 262 may be constructed as, for example, a Liquid Crystal Display (LCD), an Active Matrix Organic Light Emitting Diode (AM-OLED), or the like. The panel 262 may be implemented to be, for example, flexible, transparent, or wearable. The panel 262 may be formed to be a single module with the touch panel 252. The hologram 264 may show a three dimensional image in the air by using an interference of light. The projector 266 may display an image by projecting light onto a screen. The screen may be located, for example, inside or outside the electronic device 201. According to an embodiment, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. Additionally or alternatively, the interface 270 may, for example, include a mobile high-definition link (MHL) interface, a secure digital (SD) card/multi-media card (MMC) interface, or an infrared data association (IrDA) interface.

The audio module 280 includes hardware such as an audio processor including circuitry configured to bidirectionally convert a sound and an electrical signal. The audio module 280 may process sound information which is input or output through, for example, a speaker 282, a receiver 284, earphones 286, the microphone 288 or the like.

The image sensor module 291 is a device for capturing still and moving images, and may include one or more image sensors (e.g., a front sensor or a rear sensor), a lens (not illustrated), an image signal processor (ISP, not illustrated), or a flash (e.g., an LED or a xenon lamp, not illustrated) according to an embodiment.

The power management module 295 may manage power of the electronic device 201. Although not illustrated, the power management module 295 may include, for example, a Power Management Integrated Circuit (PMIC), a charger Integrated Circuit (IC), or a battery or fuel gauge.

The PMIC may be mounted within, for example, an integrated circuit or an SoC semiconductor. The charging methods may be classified into wired charging and wireless charging. The charger IC may charge a battery and may prevent an overvoltage or excess current from being induced or flowing from a charger. According to an embodiment, the charger IC may include a charger IC for at least one of the wired charging and the wireless charging. Examples of the wireless charging may include magnetic resonance charging, magnetic induction charging, and electromagnetic charging, and an additional circuit such as a coil loop, a resonance circuit, a rectifier or the like may be added for the wireless charging.

For example, the battery fuel gauge may measure the remaining amount of battery 296, a charging voltage and current, or temperature. The battery 296 may store or generate electricity and may supply power to the electronic device 201 by using the stored or generated electricity. The battery 296 may include, for example, a rechargeable battery or a solar battery.

The indicator 297 may display a predetermined state of the electronic device 201 or a part of the electronic device 201 (for example, the AP 210), such as a booting state, a message state, a charging state, or the like. The motor 298 may convert an electrical signal into a mechanical vibration. Although not illustrated, the electronic device 201 may include a processing unit (for example, a GPU) for supporting mobile TV. The processing unit for supporting mobile TV may process, for example, media data pursuant to a certain standard of Digital Multimedia Broadcasting (DMB), Digital Video Broadcasting (DVB), or media flow.

Each of the above described parts (or elements) of the electronic device according to various embodiments of the present disclosure may be formed of one or more components, and the name of a corresponding element may vary according to the type of an electronic device. The electronic device according to various embodiments of the present disclosure may include at least one of the above described parts and may exclude some of the parts or further include other additional parts. Further, some of the parts of the electronic device according to various embodiments of the present disclosure may be coupled to form a single entity while performing the same functions as those of the corresponding elements before the coupling.

According to various embodiments of the present disclosure, a first electronic device (e.g., the electronic device 100 of FIG. 1 or the electronic device 201 of FIG. 2) may include a touch screen, a non-transitory memory and a processor or controller including circuitry configured for operation. The processor may detect a multi-touch input, determine whether the multi-touch input is detected through one electronic device of the first electronic device or at least one second electronic device functionally connected to the first electronic device, and control an application based on whether the multi-touch input is detected through the one electronic device.

According to various embodiments, at least one second electronic device may include a touch screen.

According to various embodiments, the processor may identify whether touch coordinates corresponding to the multi-touch input are located in a touch area corresponding to the one electronic device of the first electronic device or at least one second electronic device in order to determine whether the multi-touch input is detected through the one electronic device.

According to various embodiments, when the multi-touch input is detected through the one electronic device comprised of the first electronic device or at least one second electronic device, the processor may control an application executed in the one electronic device such that the application corresponds to the multi-touch input.

According to various embodiments, when the multi-touch input is detected through at least two electronic devices comprising the first electronic device or at least one second electronic device, the processor may determine whether the same application is executed in at least two electronic devices through which the multi-touch input is detected, and when at least two electronic devices execute different applications, the processor may control the applications executed in at least two electronic devices respectively such that the applications correspond to the multi-touch input or a single touch input.

According to various embodiments, when at least two electronic devices execute the same application, the processor may identify whether at least two electronic devices expand and execute the same application, and when at least two electronic devices expand and execute the same application, the processor may control the application executed in at least two electronic devices such that the application corresponds to the multi-touch input.

According to various embodiments, the processor may identify whether information of the application executed in at least two electronic devices is expanded and displayed in at least two electronic devices.

According to various embodiments, when at least two electronic devices independently execute the same application, the processor may synchronize touch inputs detected through at least two electronic devices, and may control the applications executed in each electronic device respectively such that the applications correspond to a synchronized single touch input.

According to various embodiments, when at least one second electronic device is sensed, the processor may provide different pieces of screen information to the first electronic device and at least one second electronic device.

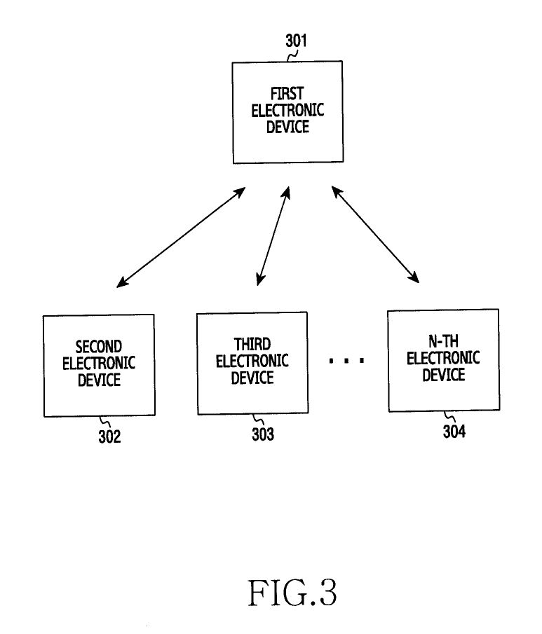

FIG. 3 illustrates a structure of an expansion type multi-screen service according to various embodiments of the present disclosure.

Referring now to FIG. 3, a first electronic device 301 (e.g., the electronic device 100 of FIG. 1) may control a plurality of other second through N-Th electronic devices (e.g., second to N-th electronic device 302, third electronic device 303, N-th electronic device 304) connected thereto. According to an embodiment, the first electronic device 301 may control an activation or a deactivation (e.g., on and off) of each of other electronic devices 302, 303 or 304.

According to an embodiment, the first electronic device 301 may control applications of each of other electronic devices 302, 303 or 304. For example, the first electronic device 301 may control a first application executed in the second electronic device 302. For example, the first electronic device 301 may control a second application executed in the third electronic device 303, and may control an (N-1)th application executed in the N-th electronic device 304.

According to an embodiment, the first electronic device 301 may control each of the other electronic devices 302, 303 or 304 such that the other electronic devices 302, 303 and 304 display different respective screens. For example, when the first electronic device 301 receives a login request signal from another electronic device among the plurality of other electronic devices 302, 303 and 304, the first electronic device 301 may transmit login screen information for a login to corresponding another electronic device. For example, the first electronic device 301 may transmit login screen information for a password or a lock pattern input to another electronic device transmitting the login request signal. When the first electronic device 301 succeeds a user authentication based on input information received from a corresponding another electronic device requesting a login, the first electronic device 301 may transmit service screen information corresponding to the user authentication to corresponding another electronic device. In other words, the first electronic device 301 may transmit information (i.e., service screen information corresponding to the user authentication) different from that of the remaining other electronic devices to another electronic device succeeding the user authentication.

According to an embodiment, when the first electronic device 301 detects a multi-touch input through the first electronic device 301(e.g., control device) and the plurality of other electronic devices 302, 303 and 304 (e.g., sub electronic devices), the first electronic device 301 may determine whether the multi-touch input is detected through one (a single) electronic device, or through multiple electronic devices. For example, the first electronic device 301 may identify whether touch coordinates (e.g., plane coordinates) corresponding to the multi-touch input are located in a touch screen area of the one electronic device. For example, when the touch coordinates (e.g., plane coordinates) corresponding to the multi-touch input are located in a touch screen area of as single (one) electronic device, the first electronic device 301 may determine that the multi-touch input is detected through the single electronic device. For example, when the touch coordinates (e.g., plane coordinates) corresponding to the multi-touch input are located in a touch screen area of a plurality of the electronic devices, the first electronic device 301 may determine that the multi-touch input is detected through at least two electronic devices from among the plurality of electronic devices (e.g., the first electronic device 301 and the plurality of other electronic devices 302, 303 and 304).

According to an embodiment, when the multi-touch input is detected through the single (one) electronic device, the first electronic device 301 may control the one(single) electronic device through which the multi-touch input is detected from among the plurality of electronic devices 301, 302, 303 and 304 such that the one electronic device provides a service (or an event) corresponding to the multi-touch input.

According to an embodiment, when the first electronic device 301 detects the multi-touch input through the plurality of electronic devices, the first electronic device 301 may identify whether each electronic device through which the multi-touch input is detected executes the same application. For example, when the first electronic device 301 detects the multi-touch through the second electronic device 302 and the third electronic device 303, the first electronic device 301 may identify whether the same application is executed in the second electronic device 302 and the third electronic device 303.

According to an embodiment, when the first electronic device 301 determines that the same application is executed in each electronic device through which the multi-touch input is detected, the first electronic device 301 may identify whether the electronic devices through which the multi-touch input is detected expand and display information corresponding to the application. For example, when the first electronic device 301 determines that the same application is executed in the second electronic device 302 and the third electronic device 303 through which the multi-touch input is detected, the first electronic device 301 may identify whether the second electronic device 302 and the third electronic device 303 display different pieces of divided area information. In other words, each of the plurality of displays may display a respective area of an expanded display of the application, as the output can be divided among the various displays. For example, when the second electronic device 302 and the third electronic device 303 display the different pieces of divided area information, the first electronic device 301 may determine that the same application is expanded and executed in the second electronic device 302 and the third electronic device 303.

According to an embodiment, when the first electronic device 301 determines that the electronic devices through which the multi-touch input is detected expand and execute the same application, the first electronic device 301 may regard the displays of the plurality of electronic devices as one display and may control to process a service (or an event) corresponding to the multi-touch input of the executed application.

According to an embodiment, when the first electronic device 301 determines that the same application is not expanded and is not executed in each electronic device through which the multi-touch input is detected, the first electronic device 301 may control the processing of a service (or an event) corresponding to the multi-touch input or the single touch input for each electronic device through which the multi-touch input is detected. For example, when the first electronic device 301 determines that each electronic device through which the multi-touch input is detected independently executes the same application, the first electronic device 301 may synchronize the touch input detected in each electronic device. The first electronic device 301 may control to provide a service corresponding to each touch input synchronized in each electronic device. For example, when the first electronic device 301 detects the multi-touch through the plurality of electronic devices displaying the same independently executed application, the first electronic device 301 may identify a distance of the touch coordinates. When the distance of the touch coordinates is included in a reference range, the first electronic device 301 may select and process only one touch input among touch inputs included in the reference range.

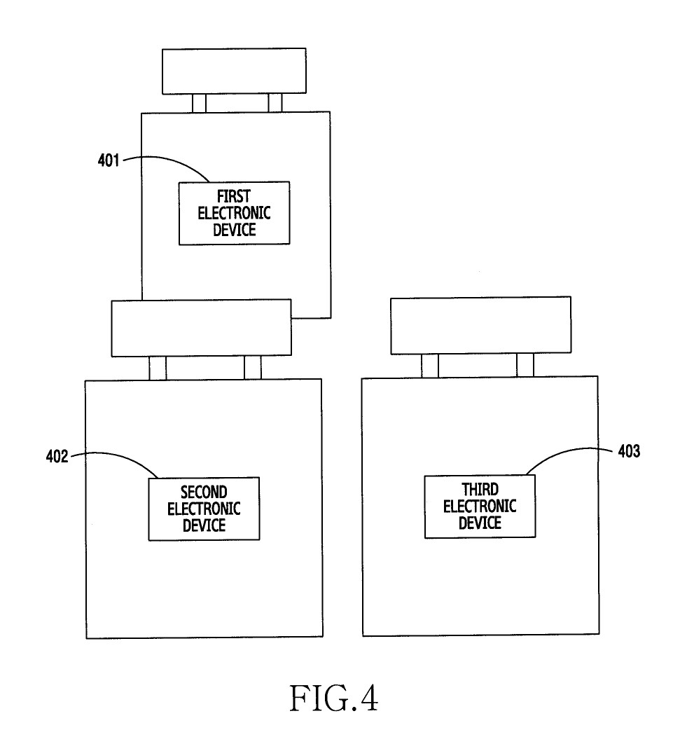

FIG. 4 illustrates a structure for controlling at least another electronic device and a screen in an electronic device according to various embodiments of the present disclosure.

Referring now to FIG. 4, a first electronic device 401 (e.g., the electronic device 100 of FIG. 1 or the first electronic device 301 of FIG. 3) (e.g., control device) may control each of other electronic devices (e.g., a second electronic device 402 or a third electronic device 403) (e.g., sub electronic devices). For example, the first electronic device 401 located adjacently to a driver's seat in a car may control the second electronic device 402 located at a left-rear seat and the third electronic device 403 located at a right-rear seat.

According to an embodiment, the first electronic device 401 may provide different screens to each of other electronic devices (e.g., the second electronic device 402 or the third electronic device 403). For example, when the first electronic device 401 receives a login request signal from the second electronic device 402, the first electronic device 401 may provide, to the second electronic device 402, a first screen (e.g., first login screen information) corresponding to a first user using the second electronic device 402. When the first electronic device 401 succeeds a user authentication based on input information provided from the second electronic device 402, the first electronic device 401 may provide, to the second electronic device 402, service screen information (e.g., a menu) which may be used by an adult such that the service screen information corresponds to the first user using the second electronic device 402. For example, when the first electronic device 401 receives a login request signal from the third electronic device 403, the first electronic device 401 may provide, to the third electronic device 403, a second screen (e.g., second login screen information) corresponding to a second user using the third electronic device 403. When the first electronic device 401 succeeds a user authentication based on input information provided from the third electronic device 403, the first electronic device 401 may provide, to the third electronic device 403, service screen information (e.g., a menu) which may be used by a minor such that the service screen information corresponds to the second user using the third electronic device 403.

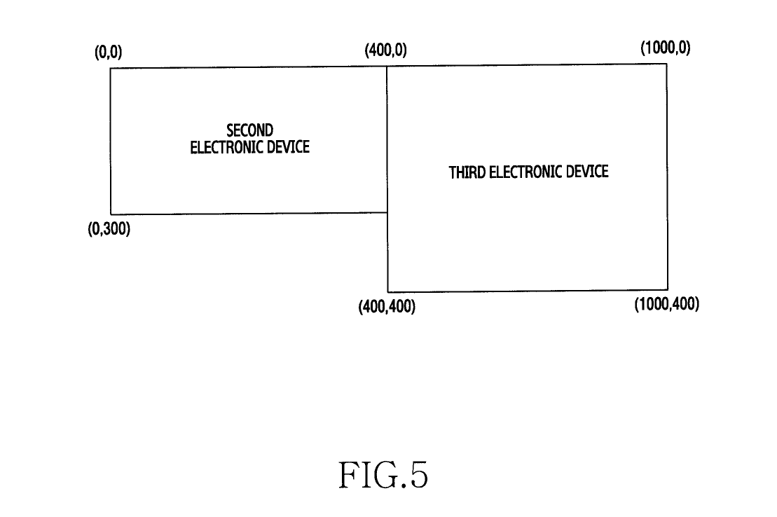

FIG. 5 illustrates a structure of a touch area using at least another electronic device recognized in an electronic device according to various embodiments of the present disclosure.

Referring to FIG. 5, when a first electronic device (e.g., the first electronic device 401 of FIG. 4) detects a multi-touch input from the first electronic device and at least another electronic device (e.g., the second electronic device 402 and/or the third electronic device 403 of FIG. 4) functionally connected to the first electronic device 401, the first electronic device 401 may identify whether the multi-touch input is detected through single electronic device.

According to an embodiment, the first electronic device 401 may identify whether the multi-touch input is detected through single electronic device based on touch coordinates (e.g., plane coordinates) of the multi-touch input. For example, when the touch coordinates corresponding to the multi-touch input are located in a touch area of the single electronic device, the first electronic device 401 may determine that the multi-touch input is detected through the single electronic device. For example, when the touch coordinates corresponding to the multi-touch input are located in touch areas of a plurality of electronic devices, the first electronic device 401 may determine that the multi-touch input is detected through the plurality of electronic devices 402, and/or 403.

For example, the first electronic device may recognize that touch screens of a second electronic device and a third electronic device functionally connected to the first electronic device are different touch areas. For example, the first electronic device may recognize touch coordinates from (0,0) to (400, 300) as a touch area of the second electronic device. The first electronic device may recognize touch coordinates from (400,0) to (1000,400) as a touch area of the third electronic device. In addition, the first electronic device 401 may recognize touch coordinates from (1000,0) to (1300,350) as a touch area of the first electronic device. For example, when the first electronic device detects a multi-touch input of touch coordinates of (200,200) and touch coordinates of (600,200), the first electronic device 401 may determine that the multi-touch input is detected through the second electronic device 402 and the third electronic device 403. For example, when the first electronic device detects a multi-touch input of touch coordinates of (200,100) and touch coordinates of (100,100), the first electronic device 401 may determine that the multi-touch input is detected through the second electronic device 402. For example, when the first electronic device detects a multi-touch input of touch coordinates of (600,200) and touch coordinates of (500,300), the first electronic device may determine that the multi-touch input is detected through the third electronic device 403.

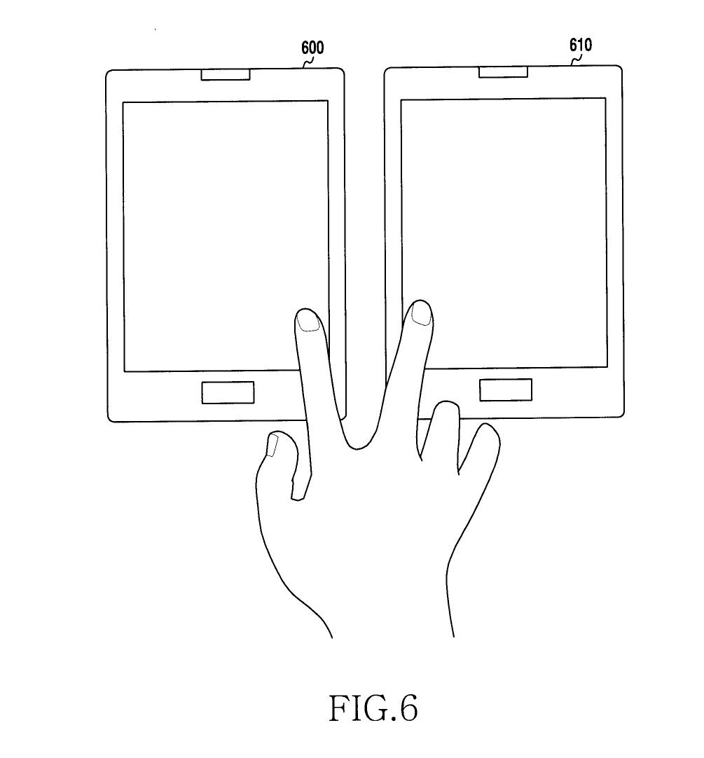

FIG. 6 illustrates a structure detecting a multi-touch input through at least another electronic device in an electronic device according to various embodiments of the present disclosure.

Referring to FIG. 6, when a first electronic device 600 (e.g., the first electronic device 100 of FIG. 1) detects the multi-touch input through the first electronic device 600 and a second electronic device 610 functionally connected to the first electronic device 600, the first electronic device 600 may identify whether the same application is executed in both the first electronic device 600 and the second electronic device 610. When the same application is executed in both the first electronic device 600 and the second electronic device 610, the first electronic device 600 may determine whether the displays of the first electronic device 600 and the second electronic device 610 expand and display the same application. For example, the first electronic device 600 may identify whether information on different areas for a specific application are being displayed respectively in the displays of the first electronic device 600 and the second electronic device 610.

According to an embodiment, when the first electronic device 600 determines that the same application is expanded and displayed in the first electronic device 600 and the second electronic device 610 through which the multi-touch input is detected, the first electronic device 600 may regard the touch screens of the plurality of electronic devices as one touch screen and may determine that the application is expanded and executed. Thus, the first electronic device 600 may perform a service (or an event) corresponding to the multi-touch input of the application. For example, when the first electronic device 600 detects the multi-touch input through the first electronic device 600 and the second electronic device 610 in which the same game application is expanded and executed, the first electronic device 600 may perform a service (or an event) corresponding to a multi-touch input of a corresponding game application.

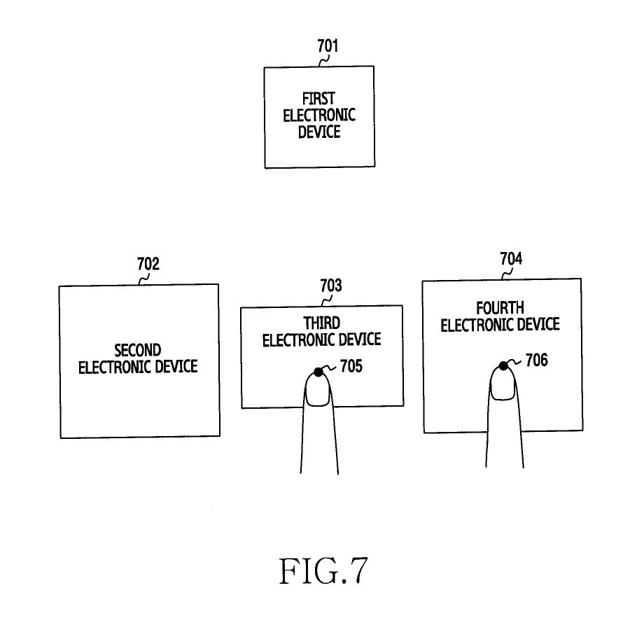

FIG. 7 illustrates a structure for copying an application according to various embodiments of the present disclosure.

Referring to FIG. 7, a first electronic device 701 (e.g., the electronic device 100 of FIG. 1) may select at least two other electronic devices which attempt to execute a random application simultaneously, from among a plurality of other electronic devices 702, 703 and 704 which are functionally connected to the first electronic device 701. For example, the first electronic device 701 may select at least another electronic device (e.g., at least one of a third electronic device 703 or a fourth electronic device 704) which will simultaneously execute an application executed in a second electronic device 702 based on a user input.

According to an embodiment, when the first electronic device 701 detects a touch input through at least another electronic device simultaneously executing the application, the first electronic device 701 may perform a service (or an event) corresponding to the touch input of the application based on a predetermined sequence. For example, when the first electronic device 701 detects the touch input through the plurality of other electronic devices 702, 703 and 704, the first electronic device 701 may determine whether the touch input is detected through at least another electronic device (e.g., at least one of the third electronic device 703 or the fourth electronic device 704) except for the second electronic device 702.

According to an embodiment, when the first electronic device 701 detects the touch input through another electronic device executing the application identical to that executed by the second electronic device 702, the first electronic device 701 may scale touch coordinates corresponding to the touch input to match the touch coordinates to a display area of the second electronic device 702. For example, when the first electronic device 701 detects a touch input of a central area 705 of the third electronic device 703 simultaneously executing an application executed in the second electronic device 702, the first electronic device 701 may extract touch coordinates of the central area 705 where the touch input is detected in the third electronic device 703. The first electronic device 701 may scale the extracted touch coordinates of the central area 705 so as to be suitable for a size of a touch screen of the second electronic device 702, and may match the touch coordinates to a display area of the second electronic device 702. For example, when the first electronic device 701 detects a touch input of a central area 706 of the fourth electronic device 704 simultaneously executing the application executed in the second electronic device 702, the first electronic device 701 may extract touch coordinates of the central area 706 where the touch input is detected in the fourth electronic device 704. The first electronic device 701 may scale the extracted touch coordinates of the central area 706 so as to be suitable for the size of the touch screen of the second electronic device 702, and may match the touch coordinates to the display area of the second electronic device 702.

According to an embodiment, when the first electronic device 701 detects a multi-touch input through the second electronic device 702 and other electronic devices 703 and 704, the first electronic device 701 may recognize the multi-touch input as a single touch input. For example, when the first electronic device 701 detects the touch input through each of the second electronic device 702 and the third electronic device 703, the first electronic device 701 may recognize the multi-touch input detected through the second electronic device 702 and the third electronic device 703 as the single touch input. For example, the first electronic device 701 may priorly process a touch input of an electronic device (e.g., the second electronic device 702) configured to perform a prior touch input, in the multi-touch input, based on predetermined prior touch input information.

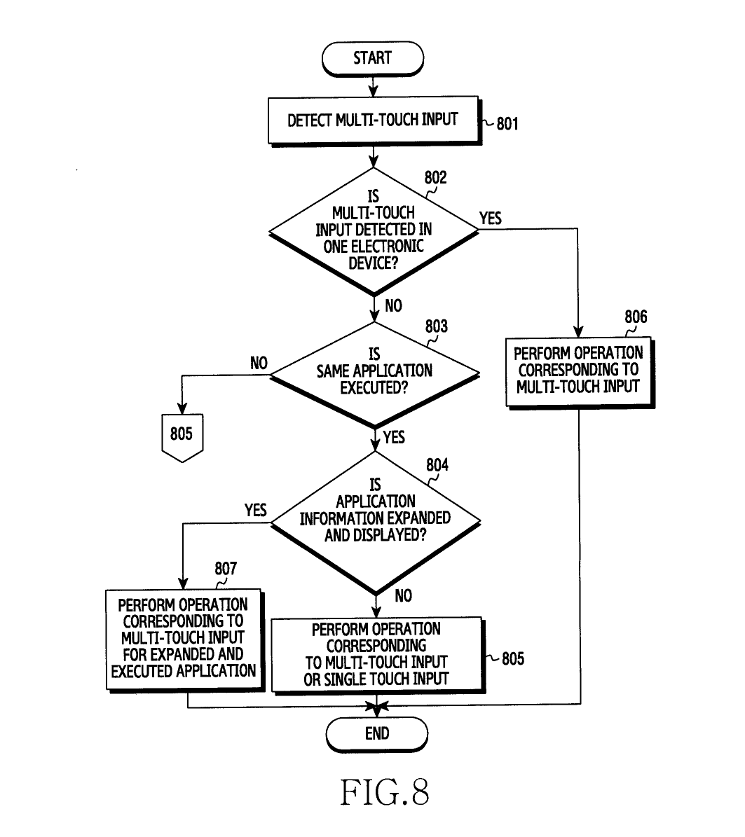

FIG. 8 illustrates a flowchart providing an operative example for processing a touch input detected through at least another electronic device in an electronic device according to various embodiments of the present disclosure.

Referring to FIG. 8, at operation 801, a first electronic device (e.g., the electronic device 100 of FIG. 1) may detect a multi-touch input. For example, the first electronic device may detect the multi-touch input through the first electronic device and at least another electronic device functionally connected to the first electronic device.

At operation 802, the first electronic device may determine whether the multi-touch input is detected through single electronic device. For example, the first electronic device may identify whether touch coordinates corresponding to the multi-touch input are located in a touch area of the single electronic device among a plurality of electronic devices (e.g., the first electronic device and at least another electronic device). For example, when the touch coordinates corresponding to the multi-touch input are located in the touch area of the one (e.g. a single) electronic device, the first electronic device may determine that the multi-touch input is detected through the one electronic device. For example, when the touch coordinates corresponding to the multi-touch input are located in the touch areas of the plurality of electronic devices, the first electronic device may determine that the multi-touch input is detected through the plurality of electronic devices.

At operation 803, when the multi-touch input is detected via the plurality of electronic devices, the first electronic device may identify whether each electronic device through which the multi-touch input is detected executes the same application. For example, when the first electronic device detects the multi-touch input through a second electronic device and a third electronic device functionally connected to the first electronic device, the first electronic device may identify whether the same application is being executed in both the second electronic device and the third electronic device.

At operation 804, when the same application is being executed in each electronic device through which the multi-touch input is detected, the first electronic device may identify whether application information is expanded (i.e. in an expanded mode) and displayed on touch screens of the plurality of electronic devices through which the multi-touch input is detected. For example, the first electronic device may identify whether information on a specific application is expanded and displayed on the touch screens of the second electronic device and the third electronic device through which the multi-touch input is detected.

At operation 805, when the plurality of electronic devices do not execute the same application or the application information is not expanded and/or is not displayed, the first electronic device may perform an operation corresponding to the multi-touch input or a single touch input so as to correspond applications executed in electronic devices, respectively.

At operation 806, when the multi-touch input is detected through the single electronic device, the first electronic device may perform an operation corresponding to the multi-touch input of an application executed in the electronic device through which the multi-touch input is detected.

At operation 807, when specific application information is expanded and displayed on touch screens of a plurality of electronic devices through which the multi-touch input is detected, the first electronic device may perform an operation corresponding to the multi-touch input of the expanded and executed application. For example, when the specific application information is expanded and displayed in the plurality of electronic devices through which the multi-touch input is detected, the first electronic device may recognize the touch screens of the plurality of electronic devices as one touch screen and may determine that the application information is displayed. Thus, the first electronic device may perform an operation corresponding to the multi-touch input for a corresponding application in response to the multi-touch input.

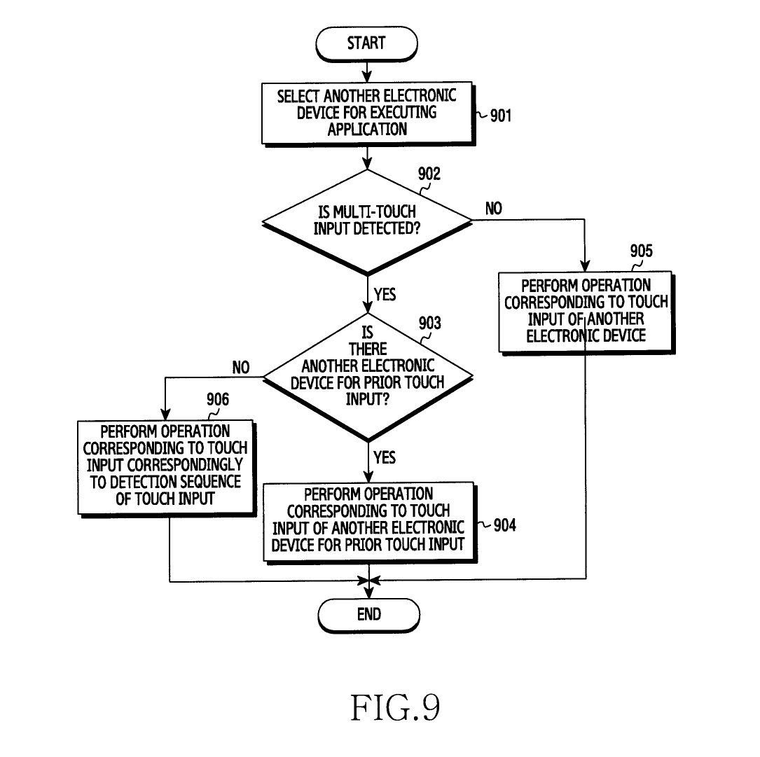

FIG. 9 illustrates a flowchart providing an operative example for processing a touch input detected through at least another electronic device in an electronic device according to various embodiments of the present disclosure.

Referring to FIG. 9, at operation 901, a first electronic device (e.g., the electronic device 100 of FIG. 1) may select a plurality of other electronic devices which attempt to execute a random application, from among a plurality of other electronic devices which are functionally connected to the first electronic device. For example, the first electronic device may select the plurality of other electronic devices for simultaneously executing an application executed in a second electronic device based on user input information.

At operation 902, the first electronic device may identify whether the multi-touch input is detected through the plurality of other electronic devices selected to execute the application. For example, the first electronic device may identify whether a touch input is detected through each of the plurality of other electronic devices selected to execute the application.

At operation 903, when the first electronic device detects the touch input (i.e., the multi-touch input) simultaneously through each of the plurality of other electronic devices selected to execute the application, the first electronic device may identify whether there is another electronic device configured to perform a prior touch input.

At operation 904, when another electronic device configured to perform the prior touch input exists, the first electronic device may perform an operation corresponding to the touch input of said another electronic device configured to perform the prior touch input. For example, when the first electronic device simultaneously senses the touch input through the second electronic device and the third electronic device, the first electronic device may priorly process the touch input detected through the second electronic device configured to perform the prior touch input.

At operation 905, when the first electronic device cannot simultaneously detect the touch input through the plurality of other electronic devices selected to execute the application, the first electronic device may perform an operation corresponding to the touch input of an application executed in another electronic device through which the touch input is detected.

At operation 906, when there is not an electronic device configured to perform the prior touch input, the first electronic device may perform an operation corresponding to the touch input of the applications executed in each of other electronic devices based on a sequence of received touch inputs.

According to an embodiment, when the first electronic device simultaneously detects the touch input through the plurality of other electronic devices functionally connected to the first electronic device, the first electronic device may sequentially perform operations corresponding to the touch inputs by dividing a touch input sequence. For example, when the first electronic device cannot divide the touch input sequence, the first electronic device may simultaneously perform the operations corresponding to the touch inputs.

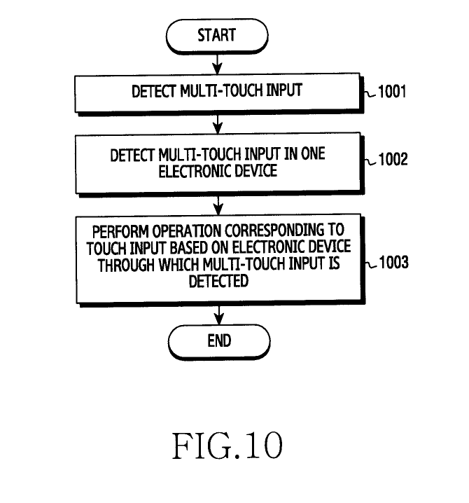

FIG. 10 illustrates a flowchart providing an operative example for processing a touch input detected through at least another electronic device in an electronic device according to various embodiments of the present disclosure.

Referring to FIG. 10, at operation 1001, a first electronic device may detect a multi-touch input through the first electronic device and at least another electronic device functionally connected to the first electronic device. For example, the first electronic device may detect the multi-touch input through a plurality of electronic devices or may detect the multi-touch input through one electronic device.

At operation 1002, the first electronic device may identify whether the multi-touch input is detected through the single electronic device (e.g., one electronic device of the first electronic device and at least another electronic device functionally connected to the first electronic device). For example, the first electronic device may identify whether touch coordinates detected through the multi-touch input are located in a touch area of the one (e.g., single) electronic device. When the touch coordinates detected through the multi-touch input are located in the touch area of the one electronic device, the first electronic device may determine that the multi-touch input is detected through the one electronic device. For example, the touch coordinates detected through the multi-touch input are located in touch areas of the plurality of electronic devices, the first electronic device may determine that the multi-touch input is detected through each electronic device.

At operation 1003, the first electronic device may perform an operation corresponding to a touch input of an application executed in a corresponding electronic device according to whether the multi-touch input is detected through the single electronic device. For example, when the multi-touch input is detected through the one (e.g., single) electronic device, the first electronic device may process the multi-touch input of the application executed in the electronic device through which the multi-touch input is detected. For example, when the plurality of electronic devices through which the multi-touch input is detected execute different applications, the first electronic device may perform an operation corresponding to the multi-touch input or a single touch input of the application executed in each electronic device through which the touch input is detected. For example, when the plurality of electronic devices through which the multi-touch input is detected execute the same application independently, the first electronic device may perform an operation corresponding to the multi-touch input or the single touch input of the application executed in each electronic device through which the touch input is detected. For example, when the plurality of electronic devices through which the multi-touch input is detected expand and execute the same application, the first electronic device may perform an operation corresponding to the multi-touch input of the application executed in the electronic device through which the touch input is detected.

According to various embodiments of the present disclosure, a method of operating a first electronic device (e.g., the electronic device 100 of FIG. 1 or the electronic device 201 of FIG. 2), may include sensing at least one second electronic device functionally connected to the first electronic device, detecting a multi-touch input in the first electronic device, determining whether the multi-touch input is detected through one electronic device of the first electronic device or at least one second electronic device, and controlling an application based on whether the multi-touch input is detected through the one electronic device.

According to various embodiments, at least two electronic devices of the first electronic device or at least one second electronic device may include a display on which a touch detection is possible.

According to various embodiments, the determining whether the multi-touch input is detected through the one electronic device may include obtaining touch coordinates corresponding to the multi-touch input, and determining whether the touch coordinates are located in a touch area corresponding to the one electronic device of the first electronic device or at least one second electronic device.

According to various embodiments, the controlling of the application may include controlling an application executed in the one electronic device such that the application corresponds to the multi-touch input, when the multi-touch input is detected through the one electronic device of the first electronic device or at least second electronic device.

According to various embodiments, the controlling of the application may include: when the multi-touch input is detected through at least two electronic devices of the first electronic device or at least one second electronic device, determining whether the same application is executed in at least two electronic devices through which the multi-touch input is detected; and when at least two electronic devices execute different applications, controlling the applications executed in at least two electronic devices respectively such that the applications correspond to the multi-touch input or a single touch input.

According to various embodiments, the method may further include: when at least two electronic devices execute the same application, identifying whether at least two electronic devices expand and execute the same application; and when at least two electronic devices expand and execute the same application, controlling the application executed in at least two electronic devices such that the application corresponds to the multi-touch input.

According to various embodiments, the identifying whether at least two electronic devices are in an expand operation and execute the same application may include identifying whether information of the application executed in at least two electronic devices is expanded and displayed in at least two electronic devices.

According to various embodiments, the method may further include: when at least two electronic devices independently execute the same application, synchronizing the touch inputs detected through at least two electronic devices; and controlling the applications executed in electronic devices respectively such that the applications correspond to a synchronized single touch input.

According to various embodiments, the method may further include: when at least one second electronic device is sensed, providing different pieces of screen information to the first electronic device and at least one second electronic device.

According to various embodiments of the present disclosure, a screen of one or more other electronic devices is independently controlled in an electronic device, and thus an effect seemed that each of other electronic devices controls displays of each of other electronic devices may be provided.

According to various embodiments of the present disclosure, a type of a touch input, which is detected through at least another electronic device for an expansion type multi-screen service, is classified and processed in an electronic device, and thus convenience of the expansion type multi-screen service may be increased.

The apparatuses and methods of the disclosure can be implemented in hardware, and in part as firmware or as software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc., that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” constitute hardware in the claimed disclosure that contain circuitry that is configured for operation. Under the broadest reasonable interpretation, the appended claims constitute statutory subject matter in compliance with 35 U.S.C. §101 and none of the elements are software per se.

The definition of the terms “unit” or “module” as referred to herein are to be understood as constituting hardware circuitry such as a CCD, CMOS, SoC, AISC, FPGA, a processor or microprocessor (a controller) configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se.

Various embodiments of the present disclosure disclosed in this specification and the drawings are merely specific examples presented in order to easily describe technical details of the present disclosure and to help the understanding of the present disclosure, and are not intended to limit the scope of the present disclosure. Therefore, it should be construed that, in addition to the embodiments disclosed herein, all modifications and changes or modified and changed forms derived from the technical idea of various embodiments of the present disclosure fall within the scope of the present disclosure.

What is claimed is:

1. A method of operating a first electronic device, the method comprising:
sensing by the first electronic device, at least one sub electronic device functionally connected to the first electronic device;
detecting, by the first electronic device, occurrence of a multi-touch input;
determining, by the first electronic device, whether the detected multi-touch input occurred through one or more of the first electronic device or the at least one sub electronic device; and
controlling by the first electronic device, an application based on whether the multi-touch input is detected via one or more of the first electronic device or the at least one sub electronic device.

2. The method of claim 1, wherein the first electronic device or the at least one sub electronic device include a touch screen.

3. The method of claim 1, wherein the determining whether the multi-touch input is detected through one or more of the first electronic device or the at least one sub electronic device comprises:
obtaining touch coordinates corresponding to the multi-touch input; and
determining whether the touch coordinates are located in a touch area corresponding to a single electronic device among the first electronic device and the at least one sub electronic device.

4. The method of claim 1, wherein the controlling the application comprises controlling an application executed in a single electronic device such that the application corresponds to the multi-touch input, when the multi-touch input is detected through the single second electronic device among the first electronic device and the at least one sub electronic device.

5. The method of claim 1, wherein the controlling the application comprises:
when the multi-touch input is detected through at least two electronic devices of the first electronic device or the at least one sub electronic device, determining whether the same application is executed in the at least two electronic devices through which the multi-touch input is detected; and
when the at least two electronic devices execute different applications, controlling the applications executed in the at least two electronic devices respectively such that the applications correspond to the multi-touch input or to a single touch input.

6. The method of claim 5, further comprising:
when the at least two electronic devices execute the same application, identifying whether at least two electronic devices expand the display of and execute the same application; and
when at least two electronic devices expand the display of and execute the same application, controlling the application executed in the at least two electronic devices such that the application corresponds to the multi-touch input.

7. The method of claim 6, wherein the identifying whether the at least two electronic devices expand display of and execute the same application comprises identifying whether displayed information of the application executed in the at least two electronic devices is expanded in size and displayed in the at least two electronic devices.

8. The method of claim 6, further comprising:
when the at least two electronic devices independently execute the same application, synchronizing touch inputs detected through the at least two electronic devices; and
controlling the applications executed in the at least two electronic devices respectively such that the applications correspond to a synchronized single touch input.

9. The method of claim 1, further comprising:
when at least one sub electronic device is sensed, providing different pieces of screen information to the first electronic device and to the at least one sub electronic device.

10. A first electronic device comprising:
a touch screen;
a memory; and
a processor operatively coupled to the memory and configured to detect a multi-touch input, to determine whether the detected multi-touch input occurred through one or more of a first electronic device or at least one sub electronic device functionally connected to first electronic device, and controls an application based on whether the multi-touch input is detected via one or more of the first electronic device or at least one sub electronic device.

11. The first electronic device of claim 10, wherein the at least one sub electronic device includes a touch screen.

12. The electronic device of claim 10, wherein the processor is further configured to identify whether touch coordinates corresponding to the multi-touch input are located in a touch area corresponding to the first electronic device or the at least one sub electronic device to determine whether the multi-touch input is detected through a single electronic device.

13. The first electronic device of claim 10, wherein, when the multi-touch input is detected through a single electronic device among the first electronic device or the at least one second electronic device, the processor controls an application executed in the single electronic device such that the application corresponds to the multi-touch input.

14. The first electronic device of claim 10, wherein, when the multi-touch input is detected through at least two electronic devices comprised of the first electronic device or the at least one sub electronic device, the processor configured to determine whether the same application is being executed in the at least two electronic devices through which the multi-touch input is detected, and when the at least two electronic devices execute different applications, the processor controls the applications executed in the at least two electronic devices respectively such that the applications correspond to the multi-touch input or a single touch input.

15. The first electronic device of claim 14, wherein, if the at least two electronic devices execute the same application, the processor identifies whether the at least two electronic devices expand a display of and execute the same application, and when the at least two electronic devices expand the display of and execute the same application, the processor controls the application executed in at least two electronic devices such that the application corresponds to the multi-touch input.

16. The first electronic device of claim 15, wherein the processor identifies whether information of the application executed in the at least two electronic devices is displayed in an expanded size in at least two electronic devices.

17. The first electronic device of claim 15, wherein, if the at least two electronic devices independently execute the same application, the processor synchronizes touch inputs detected through the at least two electronic devices, and controls the applications executed in each electronic device respectively such that the applications correspond to a synchronized single touch input.

18. The first electronic device of claim 10, wherein, if at least one sub electronic device is sensed, the processor provides different pieces of screen information to the first electronic device and the at least one sub electronic device for display.
